(19) United States
(12) Patent Application Publication
(10) Pub. No.: US 2011/0068989 A1
(43) Pub. Date: Mar. 24, 2011

(54) Antenna System with Three Degrees of Freedom

(76) Inventor: Cory Zephir Bousquet, Cranston, RI (US)

(21) Appl. No.: 12/884,358

(22) Filed: Sep. 17, 2010

Related U.S. Application Data
(60) Provisional application No. 61/244,630, filed on Sep. 22, 2009.

(51) Int. Cl. H01Q 3/12

(52) U.S. Cl. 343/761

(57) ABSTRACT

The present invention provides an improved compact antenna system with three degrees of freedom positioned on a moving platform to maintain orientation of the antenna for continuous tracking of a satellite. The system includes a cross-elevation sub-frame having two pivotal joints at each end to support an antenna reflector. The system also includes an azimuth sub-frame connected to the cross-elevation sub-frame. The system further includes a dome enclosing the reflector, cross-elevation sub-frame and the azimuth sub-frame The cross-elevation sub-frame is oriented at an angle substantially about a midpoint between the elevation angle ranges of axis of rotation for the reflector such that the reflector rotates at a point substantially to a center of the dome.

### CROSS REFERENCES

This patent application claims the benefit of U.S. Provisional Application Ser. No. 61/244,630 filed Sep. 22, 2009, the contents of which are incorporated by reference herein.

### FIELD OF THE INVENTION

The present invention is generally related to the field of satellite communications and antenna systems, and is more specifically directed to a compact antenna system with three independent displacements or aspects of motion (a.k.a. three degrees of freedom).

### BACKGROUND OF THE INVENTION

Many antenna systems mainly include two axes pointing systems but are subject to keyhole limitations when the satellite is right above the antenna such that the antenna seeks to track a satellite moving perpendicular to both axes. In other words, the antenna tries to track a satellite when the satellite tracking planes are even slightly off co-planar. In such situations, the antenna would require infinite velocity to rotate the antenna to maintain a lock on the satellite. This rotational motion of antenna causes substantial problems in the acceleration of the antenna and could result in technical failure.

In the current art, there exist three axes, a.k.a. three degrees of freedom (3DOF) pointing antenna systems that can solve the keyhole problem but sacrifice additional size/volume/footprint over the two axes system with the same antenna reflector diameter. Until now three degrees of freedom (3DOF) antennas have been relegated to larger designs. Several existing antenna manufacturers utilize an azimuth, elevation, cross-elevation mechanism for the three axis of freedom, however these antennas position the cross elevation axis at a much lower angle and mount the cross-elevation sub-frame to the front of the azimuth sub-frame. As a result, these antennas are much larger in size.

Additionally, many antenna systems have three axes of motion with the third axis substantially orthogonal to the other two axes, so they are perpendicular to each other. In the design, one needs to adjust each of the individual axes in order to rotate the antenna in all various directions. Therefore, the current systems have three independent orthogonal axes, which take up more physical space.

U.S. Pat. No. 6,911,949 discloses an antenna stabilization system for two antennas mounted on a single pedestal on a moving platform. The pedestal includes an upper alignment system, a lower alignment system and an intermediate element between the two systems. The upper alignment system has three rotational degrees of freedom for pointing the antennas relative to the intermediate element in order to provide an angular displacement between the antennas and their respective satellites. The lower alignment system has three rotational degrees of freedom to maintain the orientation of the intermediate element in order to compensate for rotation of the mobile platform such that antennas are maintained and pointed towards their respective satellites. This antenna stabilization system includes many components and requires at least two antennas.

Thus, there is a need in the art to minimize the size of the antenna system having 3DOF that can track orbiting satellites without being subject to keyhole limitations.

### SUMMARY OF THE INVENTION

One of the objectives of the present invention is to provide a compact antenna system having three degrees of freedom to be accommodated in a small size dome.

Another objective is utilizing the three degrees of freedom, i.e. azimuth, elevation, and cross-elevation axes as the three axes of motion of the antenna system to allow the antenna to track orbiting satellites without being subject to keyhole limitations at high elevations as will be describe in greater detail below.

The objectives are accomplished by designing an antenna system having a dome enclosing a reflector, a cross-elevation sub-frame and an azimuth sub-frame. The reflector is mounted directly to the cross-elevation sub-frame via first and second pivoting joints. The cross-elevation sub-frame is divided between first and second frames to form space there-between to allow a portion of an azimuth sub-frame to be securely connected between the first and the second frames. The cross-elevation sub-frame is positioned to be oriented about midway between the elevation ranges of the reflector.

### BRIEF DESCRIPTION OF THE DRAWINGS

The present invention will be more readily understood from the detailed description of exemplary embodiments presented below considered in conjunction with the attached drawings, of which:

FIG. 1A depicts a schematic drawing of one embodiment of the antenna stabilization system of the present invention.

FIG. 1B depicts a schematic drawing of a partial back view of the antenna stabilization system of FIG. 1A.

FIG. 1C depicts a schematic drawing of side view of the antenna stabilization system of FIG. 1A.

### DETAILED DESCRIPTION OF THE INVENTION

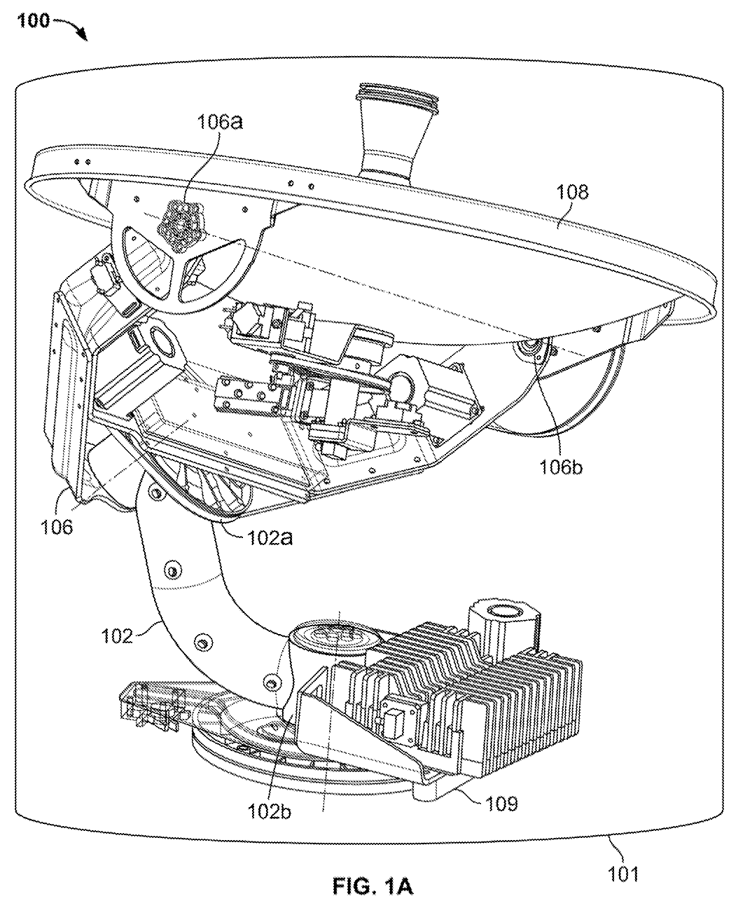

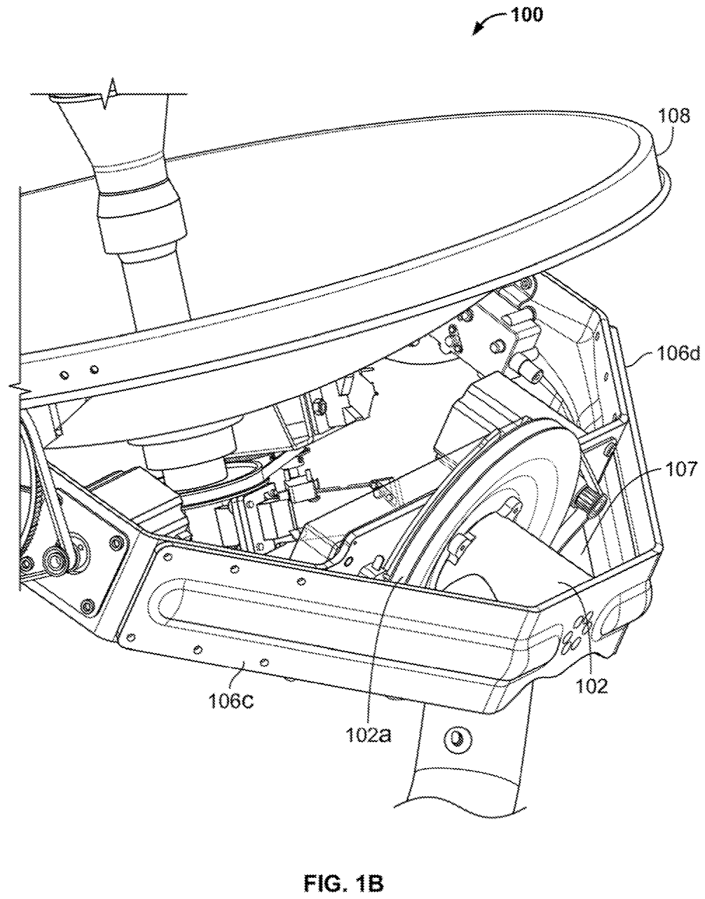

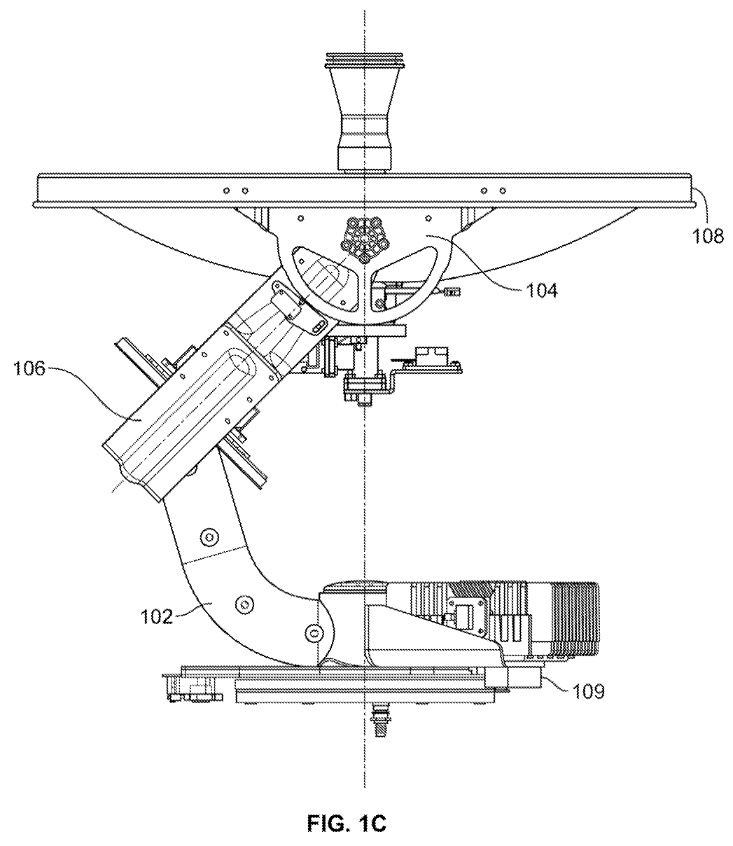

FIG. 1A illustrates a schematic view of an antenna stabilization system 100 installed on a roof of a moving platform (not shown) in accordance with an embodiment of the present invention. The system 100 includes three rotational degrees of freedom enclosed in a dome 101. The three rotational degrees of freedom include an azimuth sub-frame 102 creating the azimuth axis, a cross-elevation sub-frame 106 creating the cross-elevation axis and two pivoting joints 106a and 106b creating the elevation axis. These elements together function to adjust the orientation of a reflector 108 in order to allow the antenna to track on a separate plane than that of a satellite (not shown) to continuously track the satellite. As illustrated in FIG. 1A, the system 100 includes a reflector dish 108 mounted directly to the cross-elevation sub-frame 106 via the first and second pivoting joints 106a and 106b. The cross elevation sub-frame 106 is substantially rectangular in shape and is supported by the azimuth sub-frame 102 via joint 102a of the sub-frame 102. As shown in FIG. 1A, the azimuth sub-frame 102 is substantially elongate with a the joint 102a of a substantially circular shape at one end connected to the cross-elevation sub-frame 106 and another joint 102b connected to a base 109. Although not shown, each of the axes includes a drive motor and a bearing to provide movement to the reflector 108.

The reflector 108 of the present invention has diameter in the range of about 18 inches to about 50 inches. In a preferred embodiment the reflector 108 of the system 100 has a diameter of 24 inches and the dome 101 has a diameter of about 26 inches and height of about 31 inches, thus resulting in a very compact system in accordance with the present invention. These dimensions are about 13 to 25 percent smaller compared to currently available antenna systems having a reflector of same diameter, i.e. about 24 inches with a dome of about 34 inches in diameter and having height of about 36 inches.

Referring to FIG. 1B, there is shown a partial back view of the antenna stabilization system 100 of FIG. 1A. As illustrated in FIG. 1B, the cross-elevation sub-frame 106 is divided into a primary frame 106c and a secondary frame 106d providing for an opening 107 between the frames 106c and 106d. This division of the sub-frame 106 allows for the circular portion 102a of the azimuth sub-frame 102 to be securely placed at this opening 107 between the two frames 106c and 106d as illustrated in FIG. 1B. This division of the frame 106 and the placement of portion of the azimuth sub-frame 102 between the sub-frames 106 causes the two frames 102 and 106 to be further distanced from the center of the reflector 108, which in turn leaves more space available in the back of the reflector 108 for the feed components as shown in FIGS. 1A and 1B. Preferably, the distance between the back of the reflector 108 and the sub-frame 106 is about 6 inches. Furthermore, by placing the azimuth sub-frame 102 in between the cross elevation sub-frames 106c and 106d; the frame components of the system 100 may preferably be joined together in a compact form.

The present invention further reduces the size of the system by orienting the cross-elevation sub-frame 106 midway between the travel limits of the elevation angle range of the reflector 108. In order to determine the orientation of the cross-elevation sub-frame 106, an optimal sub-frame angle is first calculated. This optimal sub-frame angle is the angle between the axis of rotation of the antenna reflector 108 and the axis of rotation of the sub-frame 106. So, if a is the high angle value (preferably in degrees) of the elevation angle range of the axis of rotation for the reflector 108 and b is the low angle value (preferably in degrees) of the elevation angle range of the axis of rotation for the reflector 108, then optimal sub-frame angle, θ is calculated using the computation provided below:

θ=a+(b−a)/2

For example, if the elevation angle range of the axis of rotation for the antenna is designed to be between 25 degrees below the horizon (i.e. a=−25°) and 115 degrees above the horizon (i.e. b=115°), then the optimal sub-frame angle, θ is 45° (using the computation formula above) as illustrated below:

$$θ = - 25 ° + \frac{115 ° - ( - 25 ° )}{2} = 45 °$$

In the above example, the cross-elevation sub-frame 106 is oriented at 45° with respect to the reflector 108 in order to make certain that the reflector 108 is not in a co-planar position with the satellite. As a result, the reflector 108 may preferably be maintained to track the satellite in orbit regardless of the movement of the antenna and/or the moving platform. It is noted that the actual angle maybe adjusted from the ideal angle θ if needed.

FIG. 1C illustrates a side view of the system 100 of FIG. 1A in which the reflector 108 is positioned pointing straight up towards the azimuth axis and rotates about this axis. In this position, the cross-elevation sub-frame 106 is rotating at about 45 degrees with respect to the base 109. Further, in this position, it is assumed that the satellite (not shown) is directly above the antenna dish 108. However, if a satellite (not shown) moves away from the azimuth-axis towards the cross-elevation axis, the reflector 108 need to be rotated towards the cross-elevation axis in order to track the satellite. The reflector 108 is rotated by the movement of the cross-elevation sub-frame 106, which swings around to point the reflector 108 toward the satellite. The antenna 108 rotates about the cross-elevation axis relative to the cross-elevation sub-frame 106 and may also move in either the clockwise or the counter-clockwise orientation depending on the position of the satellite.

As described above, rotation of the reflector 108 in the cross-elevation axis as described above results in a change in the orientation of the cross-elevation axis. Since the cross-elevation is not orthogonal with respect to the azimuth axis and elevation axis, this change in angle in the cross-elevation axis will require the adjustment in the angles of the other two axes, i.e. the azimuth and the elevation axis in order for the system 100 to continuously track the orbiting satellites. This adjustment can be preferably be made by any known software designed to automatically readjust angles of the two axes upon change in angle of the third axis.

Thus, in the present invention, the third axis, cross-elevation axis allows the antenna to move in an axial direction that can be imagined as concentric with the elevation axis. It is this movement that results in elimination of the keyhole. Also, the 45° cross elevation approach described above solves the size/volume/footprint problem by allowing the three DOF systems to be similar in size to the two DOF systems with the same antenna reflector diameter. Furthermore, the configuration of cross elevation at 45° to the azimuth puts the reflector 108 at a center of rotation closest to the center of the radome 101 and hence allows a smaller antenna than the prior art three DOF systems that offset the center of rotation for the reflector.

While the present invention has been described with respect to what are some embodiments of the invention, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. An antenna system having three degrees of freedom positioned on a mobile platform for tracking a satellite, the system comprising:
a cross-elevation sub-frame;
a reflector mounted directly to the cross elevation sub-frame via at least first and second pivot joints;
an azimuth sub-frame coupled to the cross-elevation sub-frame; said azimuth sub-frame creates azimuth axis, wherein orientation of the cross-elevation sub-frame relative to the reflector is determined as:
θ=a(b−a)/2
where a is low angle value of the elevation angle range of the axis of rotation for the reflector and b is the high angle value of elevation angle range of the axis of rotation for the reflector.

2. The system of claim 1 further comprising a dome enclosing the reflector, the cross-elevation sub-frame and the azimuth sub-frame.

3. The system of claim 1, wherein said cross-elevation sub-frame having a first end coupled to the first pivot joint and a second end coupled to the second pivot joint, wherein said cross-elevation sub-frame includes a first and a second frame with an opening there-between.

4. The system of claim 3 further comprising a base connected to the azimuth sub-frame.

5. The system of claim 4 wherein the azimuth sub-frame having one end affixed to the base and the other end securely positioned in said opening between the first and the second sub-frames.

6. The system of claim 2, wherein said orientation of said cross-elevation sub-frame allows said reflector to rotate at a point substantially to a center of the dome.

7. The system of claim 1, wherein said three degrees of freedom are rotational degrees of freedom including said first and second joints forming elevation axis, said cross-elevation sub-frame forming cross-elevation axis and said azimuth sub-frame forming azimuth axis.

8. The system of claim 7, wherein said reflector is affixed to the elevation axis.

9. The system of claim 8, wherein said azimuth sub-frame, cross-elevation sub-frame, and the first and second pivot joints are configured to maintain orientation of the reflector for tracking the satellite.

10. The system of claim 9, wherein said first and second pivot joints rotate about the elevation axis, said cross-elevation sub-frame rotates about the cross-elevation axis and said azimuth axis rotates about azimuth axis to provide motion to the reflector and maintain said orientation of the reflector for tracking the satellite.

11. The system of claim 2, wherein said dome has a diameter of about 26 inches and height of about 31 inches.

12. The system of claim 11, wherein said reflector has a diameter in the range of about 18 inches to about 24 inches.
